(19) United States
(12) Patent Application Publication
(10) Pub. No.: US 2016/0275537 A1
(43) Pub. Date: Sep. 22, 2016

(54) APPARATUS, SYSTEM, AND METHOD OF MANAGING TRANSACTIONS OF ELECTRONIC BOOKS

(71) Applicant: Kenta YAMANO, Kanagawa (JP)

(72) Inventor: Kenta YAMANO, Kanagawa (JP)

(21) Appl. No.: 15/063,781

(22) Filed: Mar. 8, 2016

(30) Foreign Application Priority Data
Mar. 16, 2015 (JP) 2015-052270

(51) Int. Cl. G06Q 30/02; G06Q 30/06

(52) U.S. Cl. CPC G06Q 30/0208; G06Q 30/0222; G06Q 30/0635

(57) ABSTRACT

A server at a first store receives, from a first terminal at a second store, paper book identification information identifying a first paper book, and transmits to the first terminal coupon information for allowing a user to obtain or register an electronic coupon to purchase a first electronic book associated with the first paper book at a discount price. The server further receives a request for obtaining or registering the electronic coupon from a second terminal, which is a mobile terminal that obtains the coupon information from the first terminal, and transmits the electronic coupon to the second terminal. In response to a request for purchasing the first electronic book from the second terminal, the server processes the request for purchasing the first electronic book at the discount price indicated by the electronic coupon.

### CROSS-REFERENCE TO RELATED APPLICATIONS

This patent application is based on and claims priority pursuant to 35 U.S.C. §119(a) to Japanese Patent Application No. 2015-052270, filed on Mar. 16, 2015, in the Japan Patent Office, the entire disclosure of which is hereby incorporated by reference herein.

### BACKGROUND

1. Technical Field

The present invention generally relates to managing transactions of electronic books.

2. Description of the Related Art

While books in digital format, called electronic books (e-books), are largely available, some people do not regularly buy e-books. However, there may be a need for such people to exchange used paper books with e-books, if such service is available at a reasonable fee. On the other hand, used book stores usually spend so much efforts to collect used books.

### SUMMARY

In view of the above, the present inventors have realized that there is a need for a service to facilitate the exchange of used books with e-books.

Example embodiments of the present invention include an apparatus, system, and method for managing transactions of electronic books. The server at a first store, which is communicable with a first terminal at a second store, receives from the first terminal paper book identification information identifying a first paper book, and transmits to the first terminal coupon obtaining information for allowing a user to obtain an electronic coupon to purchase a first electronic book associated with the first paper book at a discount price. The server further receives a request for obtaining the electronic coupon from a second terminal, the second terminal being a mobile terminal that obtains the coupon obtaining information from the first terminal, and transmits the electronic coupon to the second terminal that has sent the request for obtaining the electronic coupon. In response to a request for purchasing the first electronic book from the second terminal, the server determines whether the request for purchasing the first electronic book includes the electronic coupon transmitted from the server to the second terminal, and processes the request for purchasing the first electronic book at the discount price indicated by the electronic coupon, based on a determination indicating that the request for purchasing the first electronic book includes the electronic coupon transmitted from the server to the second terminal.

Example embodiments of the present invention include an apparatus, system, and method for managing transactions of electronic books. The server at a first store, which is communicable with a first terminal at a second store, receives from the first terminal paper book identification information identifying a first paper book, and transmits to the first terminal coupon registration information for allowing a user to register an electronic coupon to purchase a first electronic book associated with the first paper book at a discount price. The server further receives a request for registering the electronic coupon from a second terminal, the second terminal being a mobile terminal that obtains the coupon registration information from the first terminal, and stores the electronic coupon in association with user identification information of a user operating the second terminal. In response to a request for purchasing the first electronic book from the second terminal, the server determines whether the request for purchasing the first electronic book is transmitted from the second terminal operated by the user that has sent the request for registering the electronic book, and processes the request for purchasing the first electronic book at the discount price indicated by the electronic coupon, based on a determination indicating that the request for purchasing the first electronic book is transmitted from the second terminal operated by the user that has sent the request for registering the electronic book.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram illustrating a network system including an e-book seller server according to an embodiment of the present invention;

FIG. 2 is a conceptual diagram illustrating a service of exchanging a paper book with an e-book, provided by the network system of FIG. 1;

FIGS. 3A to 3C (FIG. 3) are a schematic block diagram illustrating a hardware configuration of the network system of FIG. 1 according to an embodiment of the present invention;

FIG. 4 is a schematic block diagram illustrating a functional configuration of an e-book seller server of the network system of FIG. 1 according to an embodiment of the present invention;

FIG. 5 is a data sequence diagram illustrating operation of processing a request for exchanging a paper book with an e-book to issue an electronic coupon, performed by the e-book seller server of FIG. 4, according to an embodiment of the present invention;

FIG. 6A is an illustration of an example e-book coupon issuance screen;

FIG. 6B is an illustration of an example QR code screen with an access to a coupon download page;

FIG. 6C is an illustration of an example error screen;

FIG. 7 is an illustration of an example data structure of a book information management table;

FIG. 8A is an illustration of an example coupon download page;

FIG. 8B is an illustration of an example link page having a link to an e-book sales page;

FIG. 9 is a data sequence diagram illustrating operation of processing an order of purchasing an e-book using the electronic coupon, performed by the e-book seller server of FIG. 4, according to an embodiment of the present invention;

FIG. 10A is an illustration of an example sales page of the e-book;

FIG. 10B is an illustration of an example order confirmation screen;

FIG. 11 is an illustration of an example data structure of a sales management table;

FIG. 12 is a schematic block diagram illustrating a functional configuration of an e-book seller server of the network system of FIG. 1 according to an embodiment of the present invention;

FIG. 13 is a data sequence diagram illustrating operation of processing a request for exchanging a paper book with an e-book to register an electronic coupon, performed by the e-book seller server of FIG. 12, according to an embodiment of the present invention;

FIG. 14 is a data sequence diagram illustrating operation of processing an order of purchasing an e-book using the electronic coupon, performed by the e-book seller server of FIG. 12, according to an embodiment of the present invention;

FIG. 15A is an illustration of an example e-book coupon registration screen;

FIG. 15B is an illustration of an example QR code screen with an access to a coupon registration page;

FIG. 15C is an illustration of an example error screen;

FIG. 16A is an illustration of an example coupon registration page; and

FIG. 16B is an illustration of an example link page having a link to an e-book sales page.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

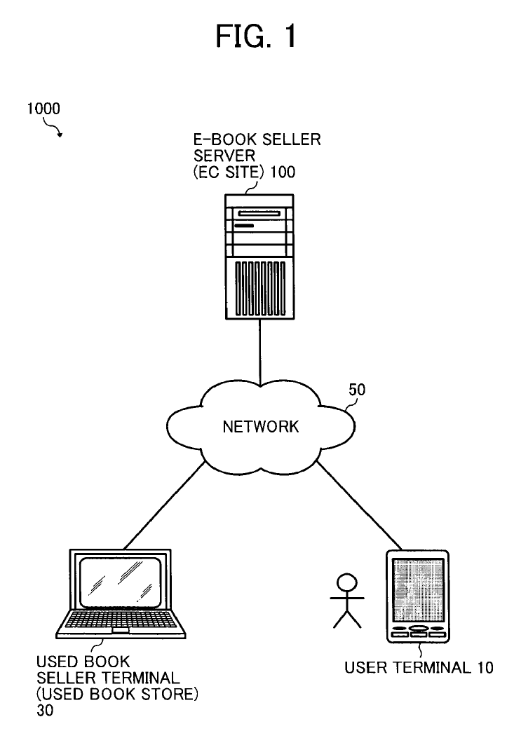

Referring to FIGS. 1 to 11, a network system 1000 including an electronic book (e-book) seller server 100 is described according to an embodiment of the present invention.

The e-book seller server 100 is a system, which provides an electronic commerce site on the Internet for selling e-books (“e-book seller site X”). As illustrated in FIG. 1, the network system 1000 includes, in addition to the e-book seller server 100, a used book seller terminal 30 provided at a used book store, and a user terminal 10, which are communicable with each other through a network 50. The network 50 may be any desired network such as the Internet. Although only one e-book seller server 100 is shown in FIG. 1 for simplicity, a plurality of servers may be provided for corresponding e-book stores on the Internet. Similarly, it is assumed that a plurality of used book seller terminals 30 are provided for corresponding used book stores. Further, any one of the server 100 and the terminal 30 in the network system 1000 could be located at any place, such as within one country, or over different countries. The user terminal 10 is a mobile terminal, such that its location changes as it is carried by the user.

For the descriptive purposes, the operator or the owner of the e-book seller server 100, or one or more PCs functioning as the e-book seller server 100, may be referred to as the e-book store. The operator or the owner of the used book seller terminal 30, or one or more PCs functioning as the used book seller terminal 30 may be referred to as the used book store.

In this disclosure, a digital content version of a book is referred to as an “e-book”, and the paper book itself is referred to as a “paper book”. In the following embodiment, the e-book seller server 100 and the used book seller terminal 30 together provide business platform that offers a right to have an e-book at a special price (even at free) in exchange of a paper book, to the user who owns the paper book, instead of offering money to the user for the paper book. In this embodiment, the used book store, who has collected the used book from the user, pays some fee to the e-book store that will sell the e-book to the user at a special price.

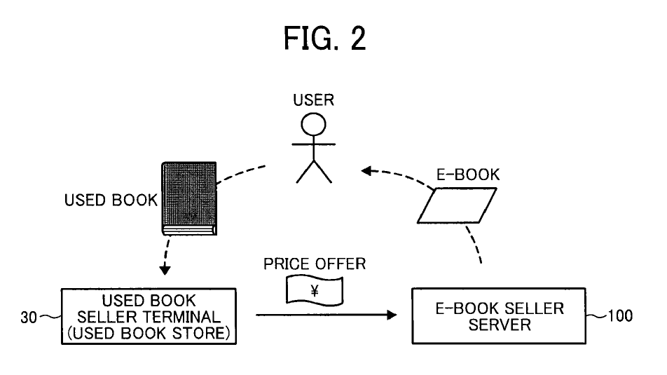

FIG. 2 describes this business platform for promoting sales of e-books as well as collection of used books according to this embodiment.

Instead of offering money for the used book, the used book store offers a right to purchase an e-book associated with the paper book at a special price, to the user who will exchange the paper book with the e-book. The e-book store sells the e-book associated with the paper book to the user who is given the right to purchase the e-book of the paper book, at the special price. The used book store thus pays no money to the user, but gives a right to purchase the e-book at a special price. The used book store pays a fee, which is determined based on a price of the used book, to the e-book store for selling the e-book to the user at the special price. The special price may include the price of zero, such that the user can have an e-book associated with the paper book at free.

The e-book store thus benefits from such business platform as sales of e-books increase or at least promoted. Although the e-book store sells the e-book at a special price, the e-book store can receive some money from the used book store.

Further, the used book store benefits from such business platform as collection of used books increases. Although the used book store pays some money to the e-book store, the used book store does not have to pay money to the user when buying the used book from the user.

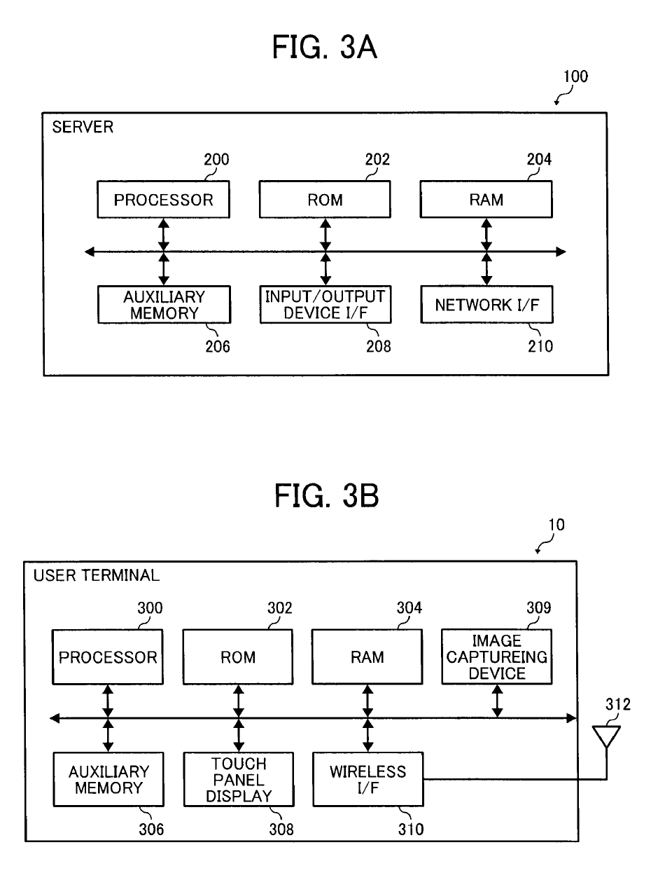

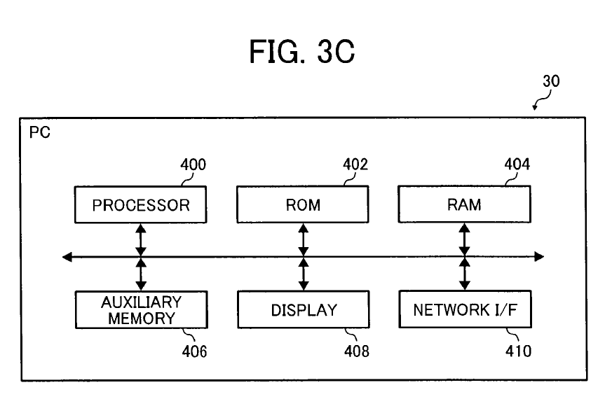

Referring to FIGS. 3A to 3C, a hardware configuration of the network system 1000 is described according to an embodiment of the present invention.

As described above, the e-book seller server 100 may be implemented by one or more computers. Referring to FIG. 3A, the e-book seller server 100 includes a processor 200, a read only memory (ROM) 202, a random access memory (RAM) 204, an auxiliary memory 206, an input/output interface (I/F) 208, and a network I/F 210, which are connected through a bus.

The processor 200 controls entire operation of the server 100. The ROM 202 is a non-volatile memory that stores various programs such as a boot program like BIOS, and firmware. The RAM 204 is a non-volatile memory that functions as a work memory for the processor 200 in executing the program. The auxiliary memory 206 may be implemented by a hard disk drive (HDD) of large-size capacity, which stores an operating system and application. The input/output I/F 208 is an interface that connects the server 100 with an input device such as a mouse, keyboard, or touch panel, or an output device such as a display. The network I/F 210 is an interface that connects the server 100 with the network 50. The server 100 of FIG. 3A operates under control of the OS to perform various operations according to the program.

FIG. 3B illustrates a hardware configuration of the user terminal 10, which may be implemented by any information processing device such as a personal computer (PC). The user terminal 10 is preferably a mobile device such as a notebook PC, a tablet PC, a personal digital assistance (PDA), which is capable of communicating wirelessly. In this embodiment, the user terminal 10 is implemented by a smart phone such that the user terminal 10 may be referred to as the smart phone 10. Referring to FIG. 3B, the smart phone 10 includes a processor 300, a ROM 302, a RAM 304, an auxiliary memory 306, a touch panel display 308, an image capturing device 309, and a wireless I/F 310.

The processor 300 controls entire operation of the user terminal 10. The ROM 302 is a non-volatile memory that stores various programs such as a boot program like BIOS, and firmware. The RAM 304 is a non-volatile memory that functions as a work memory for the processor 300 in executing the program. The auxiliary memory 306 may be implemented by a flash memory of large-size capacity, which stores an operating system and application. The touch panel display 308 (“display 308”) is a display capable of displaying various information to the user, and receiving various user inputs through a touch panel. The image capturing device 309, which may be implemented by a camera, captures an image. The wireless I/F 310 inputs or outputs wireless signals to the outside device through an antenna 312.

The used book seller terminal 30 of FIG. 1 may be implemented by, for example, a notebook PC, a tablet PC, etc. As illustrated in FIG. 3C, the used book seller terminal 30 includes a processor 400, a ROM 402, a RAM 404, an auxiliary memory 406, a display 408, and a network I/F 410.

The processor 400 controls entire operation of the used book seller terminal 30. The ROM 402 is a non-volatile memory that stores various programs such as a boot program like BIOS, and firmware. The RAM 404 is a non-volatile memory that functions as a work memory for the processor 400 in executing the program. The auxiliary memory 406 may be implemented by a HDD of large-size capacity, which stores an operating system and application. The display 408 is a display capable of displaying various information to the user. The network I/F 410 is an interface that connects the terminal 30 with the network 50.

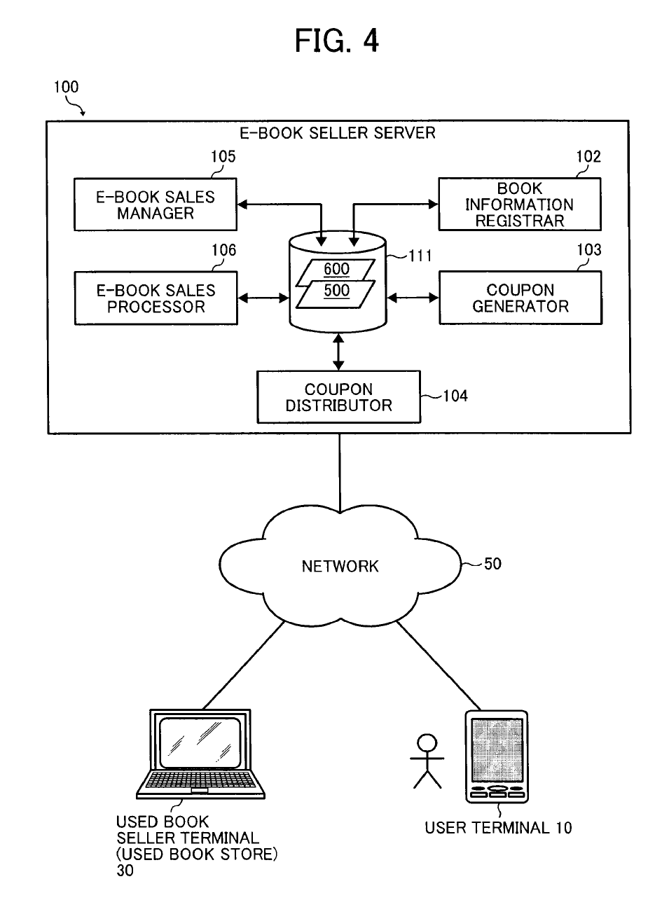

Referring to FIG. 4, a functional configuration of the e-book seller server 100 is explained according to the embodiment of the present invention.

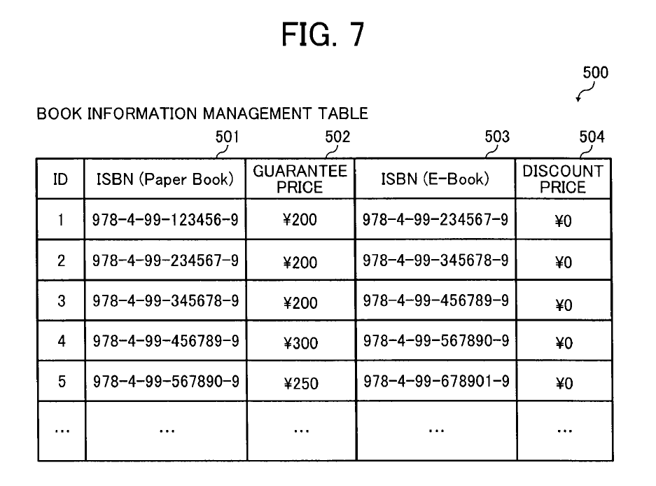

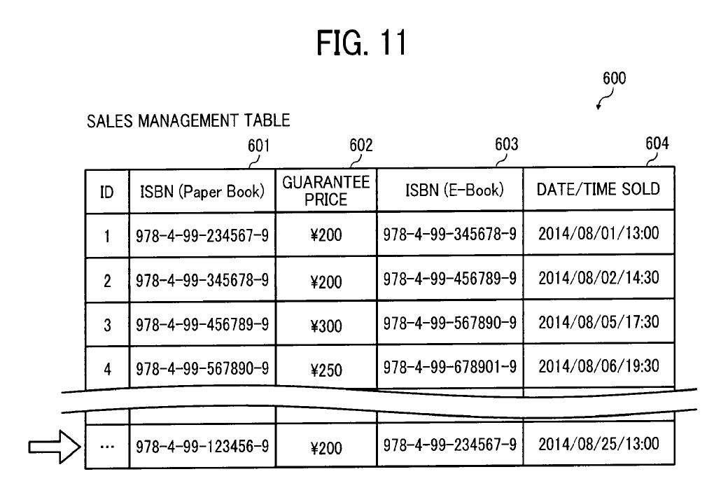

As illustrated in FIG. 4, the e-book seller server 100 includes a book information registrar 102, a coupon generator 103, a coupon distributor 104, an e-book sales manager 105, and an e-book sales processor 106. The e-book seller server 100 further includes a database III, which stores various information to be used by the e-sales seller server 100, such as a book information management table 500 of FIG. 7 and a sales management table 600 of FIG. 11.

The book information registrar 102 associates identification information for identifying a paper book with identification information for identifying an e-book. The coupon generator 103 generates an electronic coupon for purchasing an e-book at a special price. The coupon distributor 104 transmits information for obtaining the electronic coupon to the used book seller terminal 30.

The e-book sales manager 105 obtains and stores sales information regarding the e-book sold with the electronic coupon. The e-book sales processor 106 performs various processing for e-book transaction, such as managing user information, managing web pages for e-books, accepting an order, processing a request for purchasing such as processing payment from the user.

The above-described units in FIG. 4 are implemented by a plurality of instructions that are generated by the processor 200 in cooperation with any desired memory such as the ROM 202 or the auxiliary memory 206.

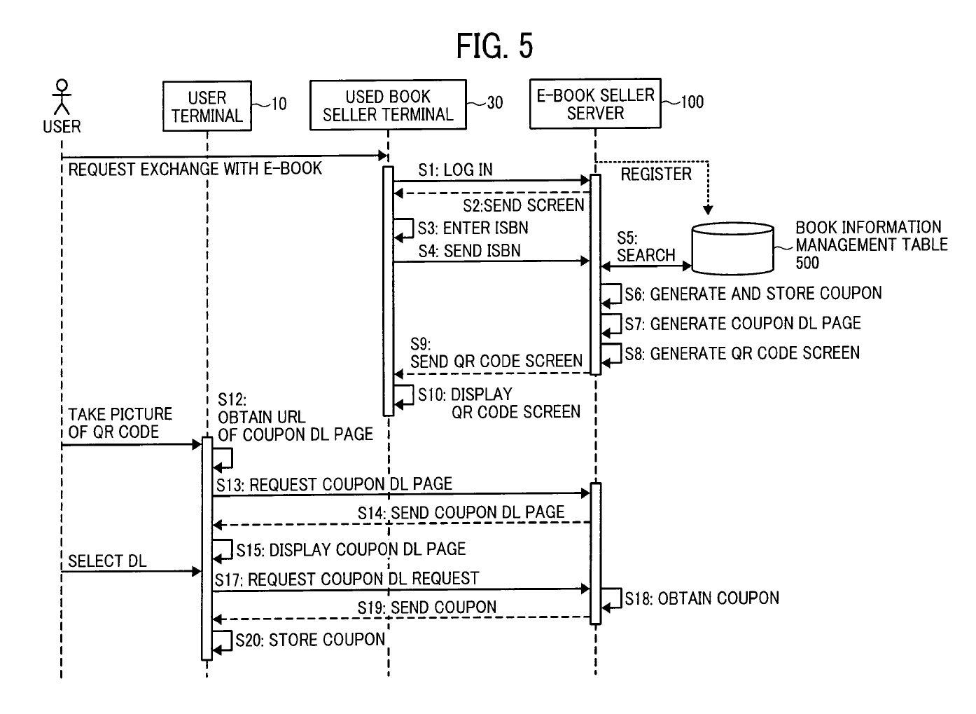

Referring to FIG. 5, operation of processing a request for exchanging a paper book with an e-book, performed by the e-book seller server 100, is explained according to an embodiment of the present invention.

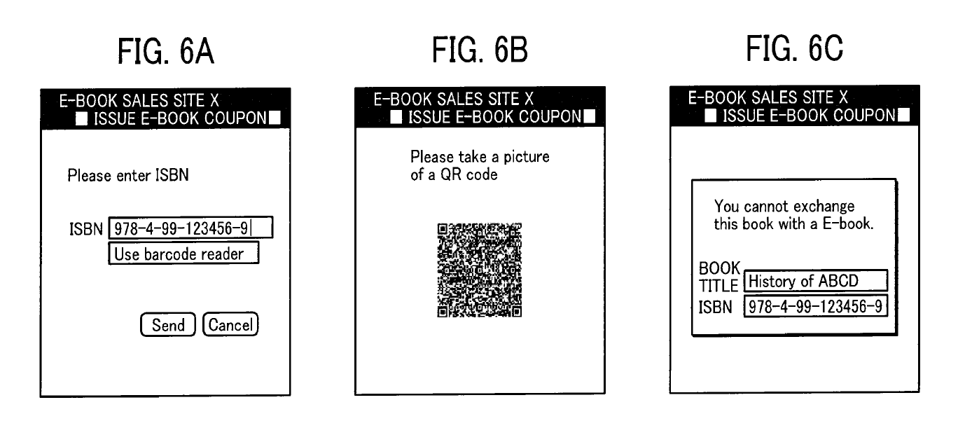

When the user brings the used book (paper book) to exchange with the e-book, at S1, a staff at the used book store operates the used book seller terminal 30 to log in the e-book sales site X provided by the e-book seller server 100. When the login is successful, at S2, the e-book seller server 100 transmits an e-book coupon issuance screen to the used book seller terminal 30. The used book seller terminal 30 causes the display 408 to display the e-book coupon issuance screen for the e-book sales site X, for example, as illustrated in FIG. 6A.

As the staff at the used book store enters identification of the used book that the user has brought on a text box of the e-book coupon issuance screen of FIG. 6A at S3, the used book seller terminal 30 receives the identification of the used book. In this example, the identification information of the used book is any identifier that uniquely identifies a title of the book, such as an International Standard Book Number (ISBN).

As the staff at the used book store selects a “send” key after entering the ISBN of the used book, at S4, the used book seller terminal 30 transmits the entered ISBN to the e-book seller server 100 through the network 50.

In alternative to manually entering the ISBN, the user may take a picture of a QR code printed on the used book. More specifically, when the “Use barcode reader” key is selected on the screen of FIG. 6A, the display 408 displays a screen requesting the staff at the used book store to capture an image of the QR code printed on the used book.

At S5, the coupon generator 103 of the e-book seller server 100 searches the book information management table 500 of FIG. 7 using the received ISBN as a search key to obtain information regarding an e-book that can be exchanged with the paper book having the obtained ISBN.

Referring to FIG. 7, the book information management table 500 is provided for each one of the used book stores. The book information management table 500 includes an ISBN (paper book)” field 501 for storing the ISBN of a paper book, a “guarantee price” field 502 for storing a guarantee price, an “ISBN (e-book)” field 503 for storing the ISBN of an e-book, and a “discount price” field 504 for storing a discount price (or a special price) to be offered to the user in purchasing the e-book in exchange of the paper book.

In this embodiment, the book information registrar 102 of the e-book seller server 100 previously registers various information in the book information management table 500. For example, the book information registrar 102 provides a wizard to the used book seller terminal 30 to guide the used book store to input various information.

According to the wizard, the used book store enters the ISBN of the used book (paper book) that the used book store will purchase, and a guarantee price, respectively. According to this input, the book information registrar 102 registers the ISBN and the guarantee price respectively in the field 501 and the field 502. The guarantee price in this example corresponds to an amount of payment that the used book store promises to pay the e-book store, when the user purchases the e-book from the e-book store at a discount price (even at free). For example, the staff at the used book store may enter the amount of money that is determined based on a market price of the used book, as a guarantee price to be entered in the field 502.

The staff at the e-book store registers the ISBN of an e-book that can be sold in the field 502, and a discount price (special price) of that e-book in the field 504. The e-book store determines the e-book, or the discount price of the e-book, while considering the guarantee price to be paid by the used book store. For example, the e-book store may register the price “0” (free) as a discount price to be offered to the user.

Referring back to FIG. 5, at S5, the coupon generator 103 searches the book information management table 500 using the ISBN of the paper book that is received from the used book seller terminal 30 at S4, to obtain the ISBN of the e-book that is associated with the entered ISBN of the paper book. Referring back to FIG. 5, at S6, the coupon generator 103 generates an electronic coupon, using information obtained from the book information management table 500. The electronic coupon includes: the ISBN of the paper book that is received from the used book seller terminal 30; the ISBN of the e-book associated with the received paper book ISBN; the guarantee price associated with the e-book ISBN; the discount price associated with the e-book ISBN; a certificate indicating a right to purchase the e-book at the discount price; and a user ID of the used book store sending the paper book ISBN. This electronic coupon is to be used by the user who requests to exchange the paper book with an e-book, when purchasing the e-book. Further, at S6, the coupon generator 103 stores the electronic coupon in a predetermined memory area.

At S7, the coupon distributor 104 of the e-book seller server 100 generates a coupon download (DL) page, which is embedded with a path to the memory area where the electronic coupon is stored.

At S8, the coupon distributor 104 further encodes the URL (path) of the coupon download page generated at S7 into a QR code, and generates a screen that includes the QR code for display.

At S9, the coupon distributor 104 transmits the QR code screen to the used book seller terminal 30. In alternative to encoding the URL of the coupon download page in the QR code, the URL of the coupon download page may be encoded in any other form such as the other two dimensional code or one dimensional code such as the barcode.

At S10, the used book seller terminal 30 causes the display 408 to display the QR code screen received from the e-book seller server 100, such as a QR code screen illustrated in FIG. 6B.

Referring back to S5, when the coupon generator 105 could not find any record having the ISBN of the paper book that is received from the used book seller terminal 30, or could not find any ISBN of the e-book associated with such paper book, the coupon generator 105 generates a message indicating that the used book that the user has brought cannot be exchanged with an e-book, and transmits such message to the used book seller terminal 30. FIG. 6C illustrates an example screen including such message for display by the display 408 of the used book seller terminal 30.

As the display 408 of the used book seller terminal 30 displays the QR code screen of FIG. 6B, the staff at the used book store asks the user to capture an image of the QR code that is displayed using a camera function of the user terminal (smart phone) 10. The user takes a picture of the QR code displayed on the display 408 using the camera of the smart phone 10. At S12, the user terminal 10 analyzes the captured QR code to obtain the URL of the coupon download page. At S13, the user terminal 10 requests the e-book seller server 100 for the obtained URL of the coupon download page, for example, by accessing the obtained URL of the coupon download page. At S14, the coupon distributor 104 of the e-book seller server 100 transmits the coupon download page, generated and stored at S8, to the user terminal 10.

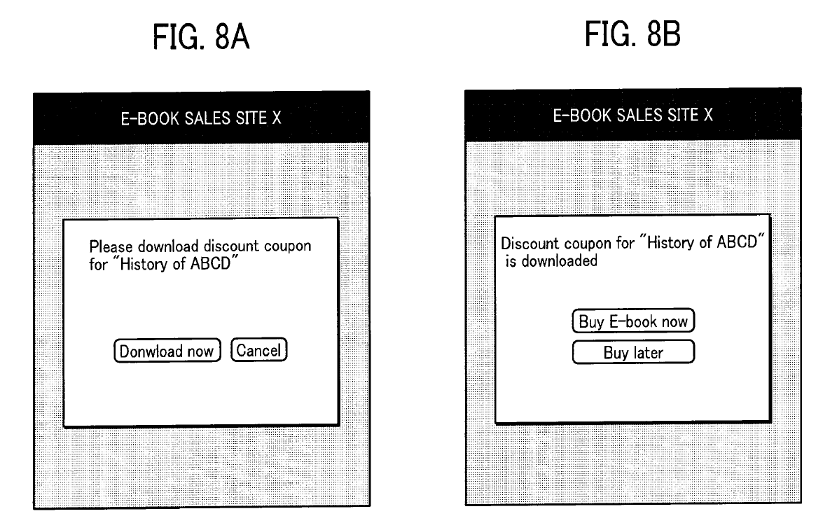

At S15, the user terminal 10 causes the display 308 to display the coupon download page, which is received from the e-book seller server 100. FIG. 8A illustrates an example coupon download page for display at the user terminal 10.

When the user selects the “Download now” key on the coupon download page of FIG. 8A, at S17, the user terminal 10 sends a request for downloading the electronic coupon to the e-book seller server 100. The download request includes the path to the electronic coupon embedded in the coupon download page.

The coupon distributor 104 obtains the electronic coupon, which is stored in the memory area specified by the path of the download request, at S18, and transmits the obtained electronic coupon to the user terminal 10 at S19.

At S20, the user terminal 10 stores the electronic coupon in a predetermined memory area of the user terminal 10. For example, the web browser of the user terminal 10 may store the electronic coupon with the web storage of HTML 5.

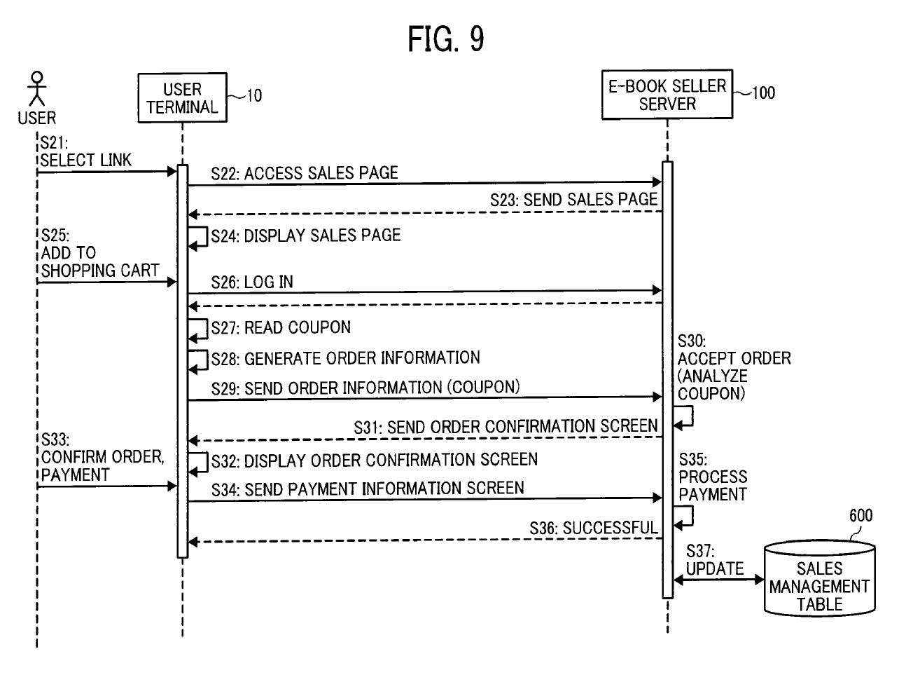

Referring to FIG. 9, operation of processing an order of purchasing an e-book using the electronic coupon, performed by the e-book seller server 100, is explained according to an embodiment of the present invention. More preferably, in this example, when the coupon distributor 104 of the e-book seller server 100 transmits the electronic coupon to the user terminal 10 as described above referring to FIG. 5, the e-book sales processor 106 transmits a link page having a link to the e-book sales page for the e-book that can be purchased with the electronic coupon to the user terminal 10.

FIG. 8B illustrates an example link page for display at the user terminal 10. The link page of FIG. 8B includes information regarding an e-book (title: “History of ABCD”) that the user can purchase at the discount price using the coupon.

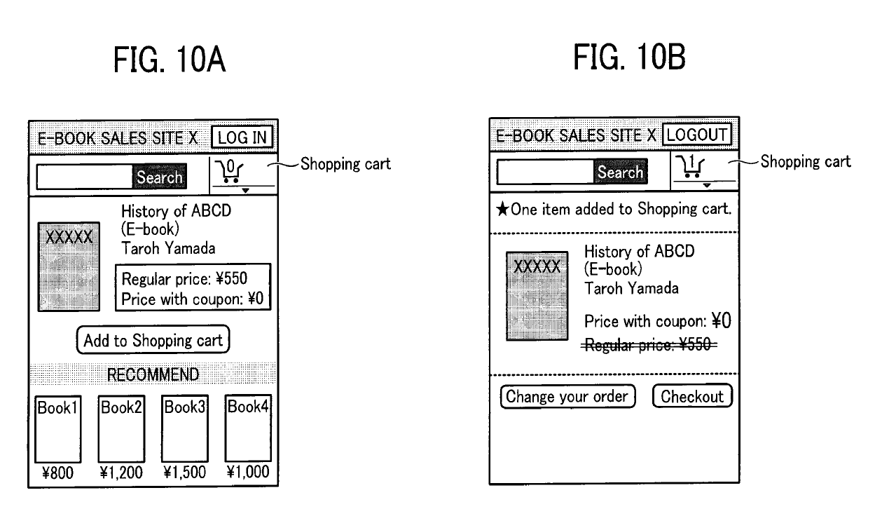

Referring to FIG. 9, when the user at the user terminal 10 selects the “Buy E-book now” key on the screen of FIG. 8B, at S21, the user terminal 10 receives such selection. At S22, the user terminal 10 accesses the sales page of the e-book “History of ABCD”, using the URL of the link page of FIG. 8B. At S23, the e-book sales processor 106 of the e-book seller server 100 transmits the sales page of the e-book “History of ABCD” to the user terminal 10. At S24, the user terminal 10 causes the display 308 to display the sales page of the e-book “History of ABCD”. FIG. 10A illustrates an example sales page of the e-book “History of ABCD”.

When the user selects the “Add to shopping cart” key on the screen of FIG. 10A, at S25, the user terminal 10 receives such instruction. At S26, the user terminal 10 switches to a login screen that requests the user to login the “e-book sales site X” of the e-book seller server 100.

At S26, the user terminal 10 logs in the e-book seller server 100. When authentication is successful, at S27, the web browser of the user terminal 10 reads out the electronic coupon that is stored at S20 (FIG. 5). At S28, the user terminal 10 generates order information including the read electronic coupon. At S29, the user terminal 10 transmits the order information to the e-book seller server 100.

At S30, the e-book sales processor 106 of the e-book seller server 100 analyzes the electronic coupon obtained from the order information to process the order of purchasing the e-book according to the contents of the electronic coupon. More specifically, the e-book seller server 100 adds the e-book “History of ABCD” to the shopping cart at the special price of 0 Yen.

At S31, the e-book sales processor 106 of the e-book seller server 100 transmits an order confirmation screen to the user terminal 10. At S32, the user terminal 10 causes the display 308 to display the order confirmation screen, such as an order confirmation screen of FIG. 10B.

The order confirmation screen of FIG. 10B indicates that the e-book “History of ABCD” is added to the shopping cart at a discount price of 0 Yen.

As the user at the user terminal 10 selects the “Checkout” key on the screen of FIG. 10B, the user terminal 10 further displays a payment screen provided by the e-book seller server 100. After inputting information such as credit card information to process payment, at S33, the user terminal 10 receives payment information from the user. At S34, the user terminal 10 sends the payment information to the e-book seller server 100.

At S35, the e-book sales processor 106 of the e-book seller server 100 processes payment using the payment information received from the user terminal 10. Assuming that the payment process is successful, at S36, the e-book seller server 100 transmits the payment result indicating that it is successful to the user terminal 10. The user can then access a specific site provided by the e-book seller server 100 to download the e-book “History of ABCD” at any desired time.

After the payment process completes, at S37, the e-book sales processor 106 of the e-book seller server 100 transmits a payment result indicating that the e-book has been sold, to the e-book sales manager 105. More specifically, the e-book sales processor 106 transmits the payment result including the electronic coupon that has been used by the user in purchasing, to the e-book sales manager 105. At S37, the e-book sales manager 105 of the e-book seller server 100 updates the sales management table 600 of FIG. 11.

The sale management table 600 is prepared for each used book store. The sale management table 600 includes an “ISBN (paper book)” field 601 for storing the ISBN of a paper book, a “guarantee price” field 602 for storing a guarantee price, an “ISBN (e-book)” field 603 for storing the ISBN of an e-book associated with the paper book, a “date/time sold” field 604 for storing the date and time when the e-book is sold.

More specifically, the e-book sales manager 105 extracts the ISBN of the paper book, the guarantee fee, and the ISBN of the e-book, from the electronic coupon included in the payment result that is received from the e-book sales processor 106, and stores such information respectively in the fields 601, 602, and 603. The e-book sales manager 105 further stores the date and time when the payment result is received in the field 604.

The e-book seller server 100 further calculates the total of guarantee prices based on information stored in the sale management table 600 for each used book store, for example, at a predetermined billing date. The total of guarantee prices is then billed to each book store.

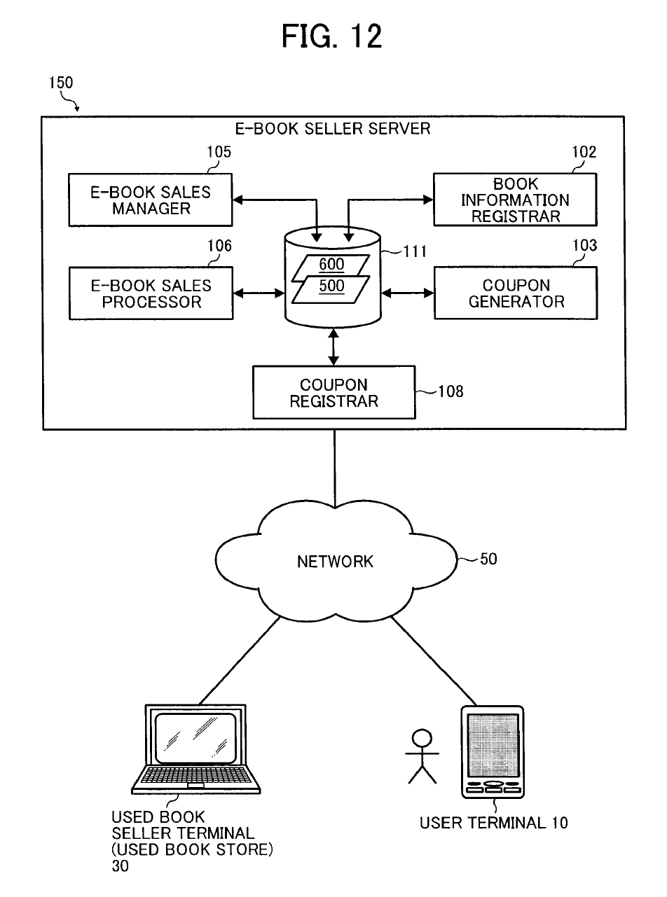

Referring to FIGS. 12 to 16, an e-book seller server 150 is described according to an embodiment of the present invention. The e-book seller server 150 of FIG. 12 is substantially similar to the e-book seller server 100 of FIG. 2 in hardware structure, such that its description is omitted. Further, in this embodiment, the used book seller terminal 30 and the user terminal 10 are substantially similar to those of FIGS. 2 and 4.

FIG. 12 illustrates a functional configuration of the e-book seller server 150 according to the embodiment of the present invention. The e-book seller server 150 includes the e-book information registrar 102, the coupon generator 103, the e-book sales manager 105, and the e-book sale processor 106, each of which operates in a substantially similar manner as described above referring to FIGS. 1 to 11. The e-book seller server 150 additionally includes a coupon registrar 108, in alternative to the coupon distributor 104 of FIG. 4.

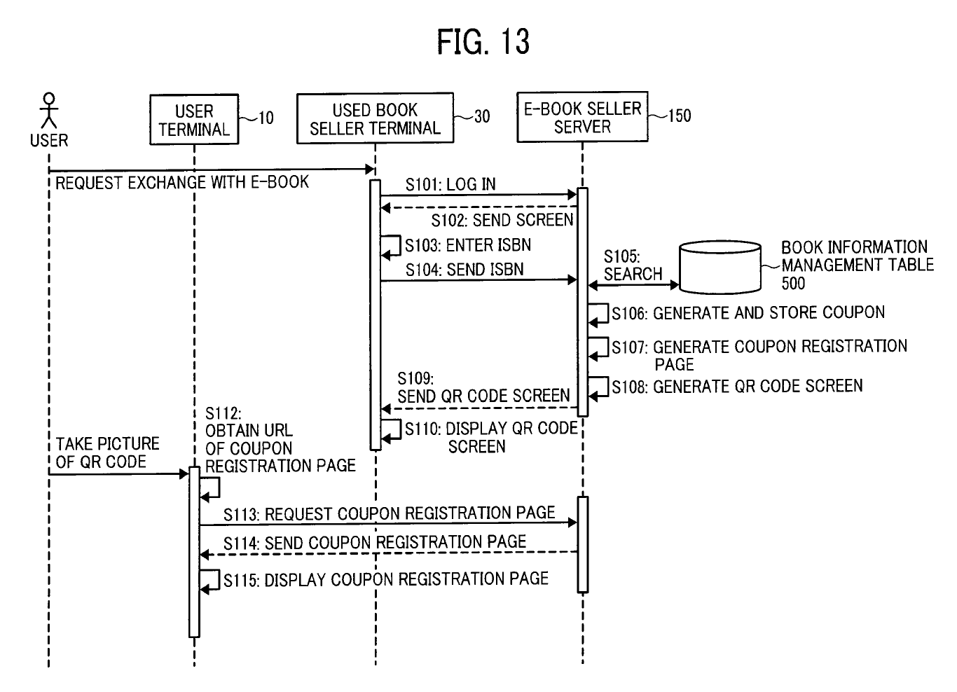

Referring to FIG. 13, operation of processing a request for exchanging a paper book with an e-book, performed by the e-book seller server 150 in cooperation with the used book seller terminal 30, is explained according to an embodiment of the present invention.

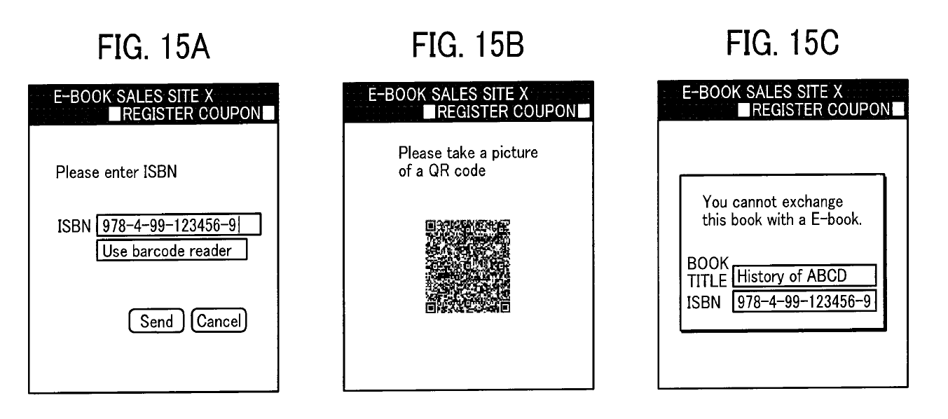

S101 to S105 are performed in a substantially similar manner as described above referring to S1 to S5 of FIG. 5, except that the e-book seller server 150 transmits an e-book coupon registration screen to the used book seller terminal 30 for display, such as an e-book coupon registration screen illustrated in FIG. 15A. The staff at the used book store then inputs information, such as the ISBN of the used book (paper book), through the e-book coupon registration screen of FIG. 15A.

When the coupon generator 103 finds the ISBN of the e-book that is associated with the entered ISBN of the paper book, at S106, the coupon generator 103 generates an electronic coupon using information obtained from the book information management table 500, and stores the electronic coupon in a predetermined memory area. The electronic coupon includes: the ISBN of the paper book that is received from the used book seller terminal 30; the ISBN of the e-book associated with the received paper book ISBN; the guarantee price associated with the e-book ISBN; the discount price associated with the e-book ISBN; and a user ID of the used book store sending the paper book ISBN.

At S107, the coupon registrar 108 of the e-book seller server 150 generates a coupon registration page, which is embedded with a path to the memory area where the electronic coupon is stored.

At S108, the coupon registrar 108 further encodes the URL (path) of the coupon registration page generated at S107 into a QR code, and generates a screen that includes the QR code for display.

At S109, the coupon registrar 108 transmits the QR code screen to the used book seller terminal 30. In alternative to encoding the URL of the coupon registration page in the QR code, the URL of the coupon registration page may be encoded in any other form such as the other two dimensional code or one dimensional code such as the barcode.

At S110, the used book seller terminal 30 causes the display 408 to display the QR code screen received from the e-book seller server 150, such as a QR code screen illustrated in FIG. 15B.

Referring back to S105, when the coupon generator 105 could not find any record having the ISBN of the paper book that is received from the used book seller terminal 30, or could not find any ISBN of the e-book associated with such paper book, the coupon generator 105 generates a message indicating that the used book that the user has brought cannot be exchanged with an e-book, and transmits such message to the used book seller terminal 30. FIG. 15C illustrates an example screen including such message for display by the display 408 of the used book seller terminal 30.

When the user takes a picture of the QR code on the screen of FIG. 15B, at S112, the user terminal 10 analyzes the captured QR code to obtain the URL of the coupon registration page. At S113, the user terminal 10 requests the e-book seller server 150 for the obtained URL of the coupon registration page, for example, by accessing the obtained URL of the coupon registration page. At S114, the coupon registrar 108 of the e-book seller server 150 transmits the coupon registration page, generated and stored at S108, to the user terminal 10.

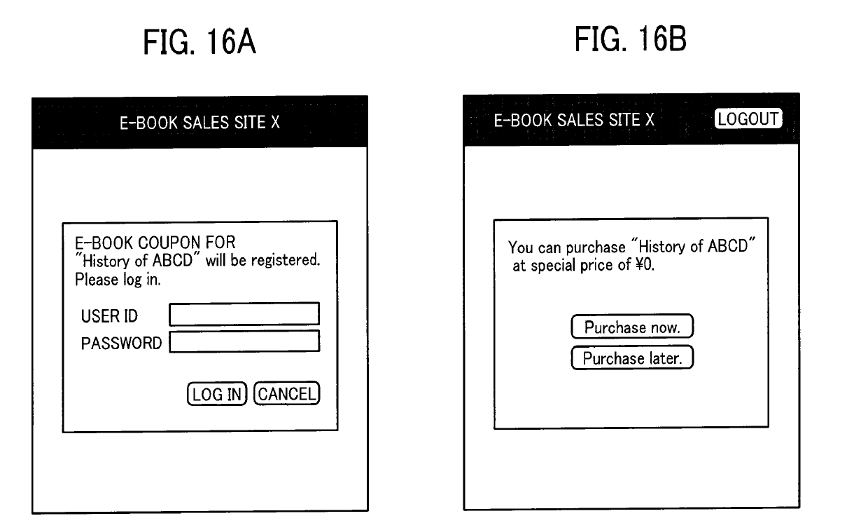

At S115, the user terminal 10 causes the display 308 to display the coupon registration page, which is received from the e-book seller server 150. FIG. 16A illustrates an example coupon registration page for display at the user terminal 10. The coupon registration page of FIG. 16A includes a message requesting the user to log in, and an entry form for user account information.

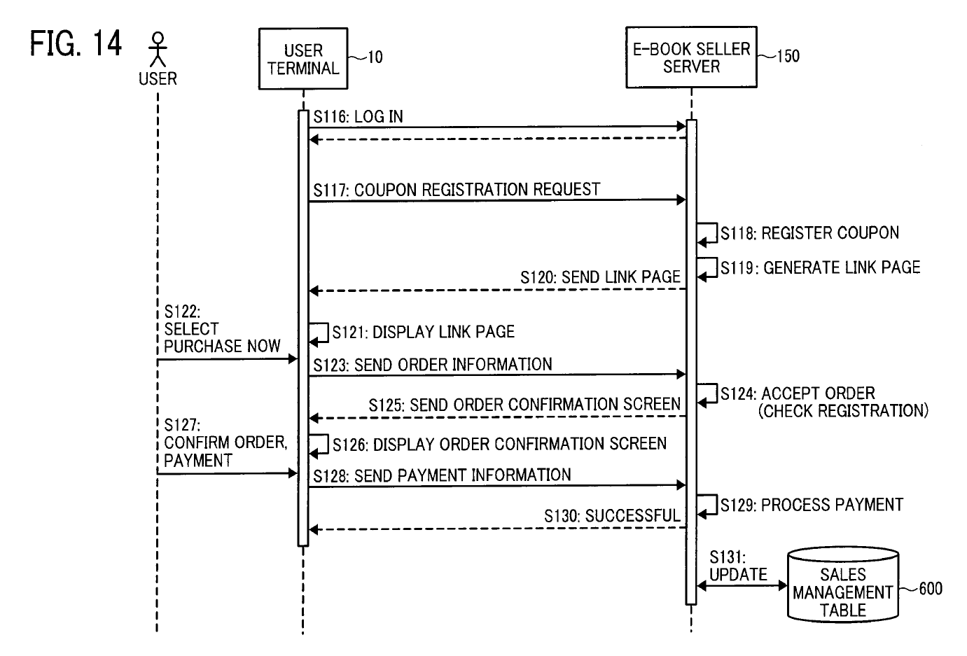

Referring to FIG. 14, operation of processing an order of purchasing an e-book using the electronic coupon, performed by the e-book seller server 150, is explained according to an embodiment of the present invention. The operation of FIG. 14 is performed after display of the coupon registration page at S115 of FIG. 13.

As the user at the user terminal 10 enters account information in the entry form, the user terminal 10 requests for log in to the e-book seller server 150 using the entered user account information. When a response indicating that the log in succeeds is received at S116, at S117, the user terminal 10 transmits a coupon registration request to the e-book seller server 150. The coupon registration request includes the path of the electronic coupon embedded in the coupon registration page.

At S118, the coupon registrar 108 of the e-book seller server 150 reads the electronic coupon, which is stored in the memory area specified by the path of the coupon registration request, and registers the read electronic coupon in association with the user information identifying the login user. The user information is, for example, a user ID of the user operating the user terminal 10.

In response to registration of the electronic coupon in association with the user, at S119, the e-book sales processor 106 generates a link page including order information for ordering an e-book (title: “History of ABCD”) that the user can purchase at the discount price using the registered coupon. At S120, the e-book sales processor 106 transmits the link page to the user terminal 10. At S121, the user terminal 10 causes the display 308 to display the link page, for example, as illustrated in FIG. 16B.

When the user at the user terminal 10 selects the “Buy E-book now” key on the screen of FIG. 16B, at S122, the user terminal 10 receives such selection. At S123, the web browser of the user terminal 10 transmits the order information of the e-book “History of ABCD”, which is embedded in the link page, to the e-book seller server 150.

At S124, the e-book sales processor 106 of the e-book seller server 150 processes the order of purchasing the e-book based on the order information received from the user terminal 10. More specifically, the e-book sales processor 106 checks whether the electronic coupon for the ordered e-book (that is, the e-book “History of ABCD” in this example) is registered in association with the user information of the login user at the user terminal 10, and if registered, adds the e-book “History of ABCD” to the shopping cart at the special price of 0 Yen.

At S125, the e-book sales processor 106 of the e-book seller server 150 transmits an order confirmation screen to the user terminal 10. At S126, the user terminal 10 causes the display 308 to display the order confirmation screen, such as an order confirmation screen of FIG. 10B.

The order confirmation screen of FIG. 10B indicates that the e-book “History of ABCD” is added to the shopping cart at a discount price of 0 Yen.

S127 to S131 are performed in a substantially similar manner as described above referring to S33 to S37 of FIG. 9.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, in the above-described embodiments, the used book store pays a fee to the electronic book store for selling en electronic book to a user who has brought a used book to the used book store. In any one of the embodiments, the electronic book store may be any store that has a virtual place where the user can visit, such as any provider that has a website. On the other hand, the used book store may be any store that has a physical place where the user can visit. That is, as long as there is a place for providing such service to exchange the used book store that the user has brought, with a right to have an electronic coupon, such place is called as the used book store in this disclosure. Accordingly, the used book store does not necessarily have to have the used books or any books for sales. Alternatively, the used book store may additionally sell any used book, and/or any new book, so that the user who visits the used book store can purchase.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions.

Further, the network in this embodiment can comprise any conventional terrestrial or wireless communications network, such as the Internet. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, MO, DVD, flexible disk, EEPROM, EPROM, magnetic tape device or solid state memory device. Further, the computer software may be written in any language such as C, C++, C#, or Java.

1. A method for managing transactions of electronic books performed by a server at a first store, the server communicable with a first terminal at a second store, the method comprising:
receiving, from the first terminal, paper book identification information identifying a first paper book;
transmitting, to the first terminal, coupon obtaining information for allowing a user to obtain an electronic coupon to purchase a first electronic book associated with the first paper book at a discount price;
receiving a request for obtaining the electronic coupon from a second terminal, the second terminal being a mobile terminal that obtains the coupon obtaining information from the first terminal;
transmitting the electronic coupon to the second terminal that has sent the request for obtaining the electronic coupon;
determining, in response to a request for purchasing the first electronic book from the second terminal, whether the request for purchasing the first electronic book includes the electronic coupon transmitted from the server to the second terminal; and
processing the request for purchasing the first electronic book at the discount price indicated by the electronic coupon, based on a determination indicating that the request for purchasing the first electronic book includes the electronic coupon transmitted from the server to the second terminal.

2. The method of claim 1, further comprising:
generating a download page for downloading the electronic coupon; and
transmitting an image encoded with a path to the download page to the first terminal as the coupon obtaining information for display at the first terminal.

3. The method of claim 1, further comprising:
storing in a memory, book information that associates, for each one of paper books that the second store has registered, an electronic book that the first store has registered for selling at a discount price to a user who brings the paper book to the second store;
identifying the first electronic book associated with the first paper book identified with the received paper book identification information, using the book information; and
generating the electronic coupon so as to include the received paper book identification information identifying the first paper book, and electronic book identification information identifying the first electronic book.

4. The method of claim 3, wherein the book information further associates, for each one of paper books that the second store has registered, the discount price of the electronic book, and a guarantee price that the second store will pay the first store for selling the electronic book at the discount price to the user, the method further comprising:
obtaining the discount price of the first electronic book and the guarantee price for selling the first electronic book to the user who brings the first paper book using the book information, so as to further include the obtained guarantee price and discount price in the electronic coupon.

5. The method of claim 4, further comprising:
receiving store identification information identifying the second store that sends the paper book identification information of the first paper book,
wherein the electronic coupon further includes the store identification information.

6. The method of claim 5, further comprising:
extracting the guarantee price and the store identification information, respectively, from the electronic coupon included in the request for purchasing the first electronic book that is received from the second terminal; and
storing the extracted guarantee price by the extracted store identification information, every time the request for purchasing the electronic book is processed.

7. A method for managing transactions of electronic books performed by a server at a first store, the server communicable with a first terminal at a second store, the method comprising:
receiving, from the first terminal, paper book identification information identifying a first paper book;
transmitting, to the first terminal, coupon registration information for allowing a user to register an electronic coupon to purchase a first electronic book associated with the first paper book at a discount price;
receiving a request for registering the electronic coupon from a second terminal, the second terminal being a mobile terminal that obtains the coupon registration information from the first terminal;
storing the electronic coupon in association with user identification information of a user operating the second terminal;
determining, in response to a request for purchasing the first electronic book from the second terminal, whether the request for purchasing the first electronic book is transmitted from the second terminal operated by the user that has sent the request for registering the electronic book; and
processing the request for purchasing the first electronic book at the discount price indicated by the electronic coupon, based on a determination indicating that the request for purchasing the first electronic book is transmitted from the second terminal operated by the user that has sent the request for registering the electronic book.

8. The method of claim 7, further comprising:
generating a registration page for registering the electronic coupon; and
transmitting an image encoded with a path to the registration page to the first terminal as the coupon registration information for display at the first terminal.

9. The method of claim 7, further comprising:
storing in a memory, book information that associates, for each one of paper books that the second store has registered, an electronic book that the first store has registered for selling at a discount price to a user who brings the paper book to the second store;
identifying the first electronic book associated with the first paper book identified with the received paper book identification information, using the book information; and
generating the electronic coupon so as to include the received paper book identification information identifying the first paper book, and electronic book identification information identifying the first electronic book.

10. The method of claim 9, wherein the book information further associates, for each one of paper books that the second store has registered, the discount price of the electronic book, and a guarantee price that the second store will pay the first store for selling the electronic book at the discount price to the user, the method further comprising:
obtaining the discount price of the first electronic book and the guarantee price for selling the first electronic book to the user who brings the first paper book using the book information, so as to further include the obtained guarantee price and discount price in the electronic coupon.

11. The method of claim 10, further comprising:
receiving store identification information identifying the second store that sends the paper book identification information of the first paper book,
wherein the electronic coupon further includes the store identification information.

12. The method of claim 11, further comprising:
extracting the guarantee price and the store identification information, respectively, from the electronic coupon that is stored in association with the user identification information of the user operating the second terminal that sends the request for purchasing the first electronic book; and
storing the extracted guarantee price by the extracted store identification information, every time the request for purchasing the electronic book is processed.

13. A system for managing transactions of electronic books, provided at a first store, the system comprising:
a network interface communicable with a first terminal provided at a second store and configured to:
receive, from the first terminal, paper book identification information identifying a first paper book;
transmit, to the first terminal, coupon obtaining information for allowing a user to obtain an electronic coupon to purchase a first electronic book associated with the first paper book at a discount price;
receive a request for obtaining the electronic coupon from a second terminal, the second terminal being a mobile terminal that obtains the coupon obtaining information from the first terminal; and
transmit the electronic coupon to the second terminal that has sent the request for obtaining the electronic coupon; and
circuitry configured to:
determine, in response to a request for purchasing the first electronic book from the second terminal, whether the request for purchasing the first electronic book includes the electronic coupon transmitted to the second terminal; and
process the request for purchasing the first electronic book at the discount price indicated by the electronic coupon, based on a determination indicating that the request for purchasing the first electronic book includes the electronic coupon transmitted to the second terminal.

14. The system of claim 13, wherein
the circuitry generates a download page for downloading the electronic coupon, and
the network interface transmits an image encoded with a path to the download page to the first terminal as the coupon obtaining information for display at the first terminal.

15. The system of claim 13, further comprising:
a memory configured to store book information that associates, for each one of paper books that the second store has registered, an electronic book that the first store has registered for selling at a discount price to a user who brings the paper book to the second store,
wherein the circuitry is further configured to:
identify the first electronic book associated with the first paper book identified with the received paper book identification information, using the book information; and
generate the electronic coupon so as to include the received paper book identification information identifying the first paper book, and electronic book identification information identifying the first electronic book.

16. The system of claim 15, wherein the book information further associates, for each one of paper books that the first store has registered, the discount price of the electronic book, and a guarantee price that the second store will pay the first store for selling the electronic book at the discount price to the user, and
the circuitry is further configured to obtain the discount price of the first electronic book and the guarantee price for selling the first electronic book to the user who brings the first paper book using the book information, so as to further include the obtained guarantee price and discount price in the electronic coupon.

17. The system of claim 16, wherein the network interface is further configured to receive store identification information identifying the second store that sends the paper book identification information of the first paper book, and
wherein the electronic coupon further includes the store identification information.

18. The system of claim 17, wherein the circuitry is further configured to
extract the guarantee price and the store identification information, respectively, from the electronic coupon included in the request for purchasing the first electronic book that is received from the second terminal, and
store the extracted guarantee price by the extracted store identification information, every time the request for purchasing the electronic book is processed.
